(19) United States
(12) Patent Application Publication
(10) Pub. No.: US 2019/0294274 A1
(43) Pub. Date: Sep. 26, 2019

(54) TOUCH SCREEN PANEL AND TOUCH SENSING SYSTEM INCLUDING THE SAME

(71) Applicant: SAMSUNG ELECTRONICS CO., LTD., SUWON-SI (KR)

(72) Inventors: Sung-yong CHO, Hwaseong-si (KR); Young-joo Lee, Uijeongbu-si (KR); Jin-bong Kim, Yongin-si (KR); Yoon-kyung Choi, Seoul (KR)

(21) Appl. No.: 16/356,024

(22) Filed: Mar. 18, 2019

(30) Foreign Application Priority Data
Mar. 21, 2018 (KR) 10-2018-0032895

(51) Int. Cl. G06F 3/044; G06F 3/041

(52) U.S. Cl. CPC G06F 3/044; G06F 2203/04112; G06F 3/0416; G06F 3/0412

(57) ABSTRACT

A touch panel and a touch sensing system including the touch panel are disclosed. The touch panel includes a substrate and a plurality of electrodes arranged on the substrate and interdigitated with each other. Each of the electrodes may include a body portion and a plurality of protruding portions extending away from the body portion, where the electrodes are interdigitated with each other via the protruding portions.

### CROSS-REFERENCE TO RELATED APPLICATION

This application claims the benefit of Korean Patent Application No. 10-2018-0032895, filed on Mar. 21, 2018, in the Korean Intellectual Property Office, the disclosure of which is incorporated herein by reference in its entirety.

### TECHNICAL FIELD

The inventive concept relates to a touch panel, and more particularly, to a touch screen panel having improved touch sensing sensitivity, and a touch sensing system including the same.

### DISCUSSION OF THE RELATED ART

A touch panel is an input device that allows a user to input a command by selecting an instruction displayed on a screen of a display device or the like and/or by applying a predetermined gesture to a device surface proximate the touch panel with a human hand or a touch pen. A touch panel may substitute for a mouse, keyboard or other input device, and when integrated with or overlapping a display screen may be referred to as a touch screen panel. In the case of a capacitive-type touch panel, when a conductive object such as a finger or touch pen approaches or touches the touch panel, a capacitance value at a point to which a touch input is applied among a plurality of touch sensing electrodes provided on the touch panel may increase. Accordingly, an occurrence of the touch input and its point of occurrence may be sensed.

### SUMMARY

The inventive concept provides a touch panel capable of improving a touch sensing performance and/or reducing the number of touch sensing electrodes provided thereon, and a touch sensing system including the touch panel.

According to an aspect of the inventive concept, there is provided a touch panel including a substrate and a plurality of electrodes arranged on the substrate and interdigitated with each other. Each of the electrodes may include a body portion and a plurality of protruding portions extending away from the body portion, where the plurality of electrodes are interdigitated with each other via the protruding portions.

According to another aspect of the inventive concept, there is provided a touch sensing system including: a touch screen panel including a plurality of touch sensing electrodes and a plurality of traces respectively connected to the plurality of touch sensing electrodes; and a touch controller configured to provide a driving signal to the plurality of touch sensing electrodes via the plurality of traces and acquire touch data based on a sensing signal received from the plurality of touch sensing electrodes via the plurality of traces, wherein each of the plurality of touch sensing electrodes includes a body portion, a first edge portion and a second edge portion formed integrally with the body portion at respective first and second sides of the body portion, and each having a symmetrical comb structure.

According to another aspect of the inventive concept, there is provided a touch screen panel including: a touch sensing area including a plurality of touch sensing electrodes, wherein each of the plurality of touch sensing electrodes includes a metallic mesh, and at least one of the plurality of touch sensing electrodes includes a body portion and a plurality of protruding portions extending from the body portion; and a trace area including a plurality of traces, each connected to a respective one of the plurality of touch sensing electrodes.

### BRIEF DESCRIPTION OF THE DRAWINGS

Embodiments of the inventive concept will he more dearly understood from the following detailed description taken in conjunction with the accompanying drawings, in which like reference characters indicate like elements or features, wherein:

FIG. 1 is a diagram illustrating a touch sensing system according to an embodiment of the inventive concept;

FIG. 2 is a diagram for explaining a method of sensing a touch input on a touch screen panel with a sensing circuit;

FIG. 3A is a plan view of an example touch sensing electrode according to an embodiment;

FIG. 3B illustrates a touch sensing electrode with a detail showing conductive material thereof having a mesh structure according to an embodiment;

FIGS. 4A and 4B are plan views of touch sensing electrodes according to respective embodiments;

FIG. 5A is a plan view of a touch sensing electrode according to an embodiment, and shows two positions on a protruding portion thereof;

FIGS. 5B, 5C, 5D and 5E illustrate respective pairs of mesh patterns at the two positions in FIG. 5A according to respective embodiments;

FIG. 6A illustrates a pattern of touch sensing electrodes according to an embodiment of the inventive concept;

FIG. 6B illustrates a pattern of touch sensing electrodes according to a comparative example;

FIG. 6C shows a graph of capacitance of a sensing capacitor by position within the patterns in FIGS. 6A and 6B;

FIGS. 7A and 7B are diagrams illustrating respective arrangements of touch sensing electrodes of a touch screen panel according to respective embodiments;

FIG. 8A is a plan view of a touch screen panel according to an embodiment;

FIG. 8B is a cross-sectional view of the touch screen panel taken along a line A-A′ in FIG. 8A;

FIG. 9A is a plan view of a touch screen panel according to an embodiment;

FIG. 9B is a cross-sectional view of the touch screen panel taken along a line B-B′ in FIG. 9A;

FIG. 10 is a diagram illustrating a portion of a touch screen panel according to an embodiment;

FIG. 11 is a block diagram illustrating an electronic system including a touch screen panel according to an embodiment; and

FIGS. 12A, 12B and 12C are vertical cross-sectional views schematically illustrating respective embodiments of a laminated structure of a touch display in FIG. 11.

### DETAILED DESCRIPTION OF EMBODIMENTS

Hereinafter, embodiments of the inventive concept will be described in detail with reference to the accompanying drawings.

Herein, the terms column direction and row direction or like terms may be used as relative terms intended to mean first and second directions orthogonal to each other, unless specifically defined otherwise for a particular embodiment. Columns and rows of electrodes discussed herein, when disposed within an overall rectangular structure, are not necessarily arranged parallel to any side of the rectangular structure containing the rows and columns, but may be arranged diagonally, obliquely or parallel to the sides of the rectangular structure.

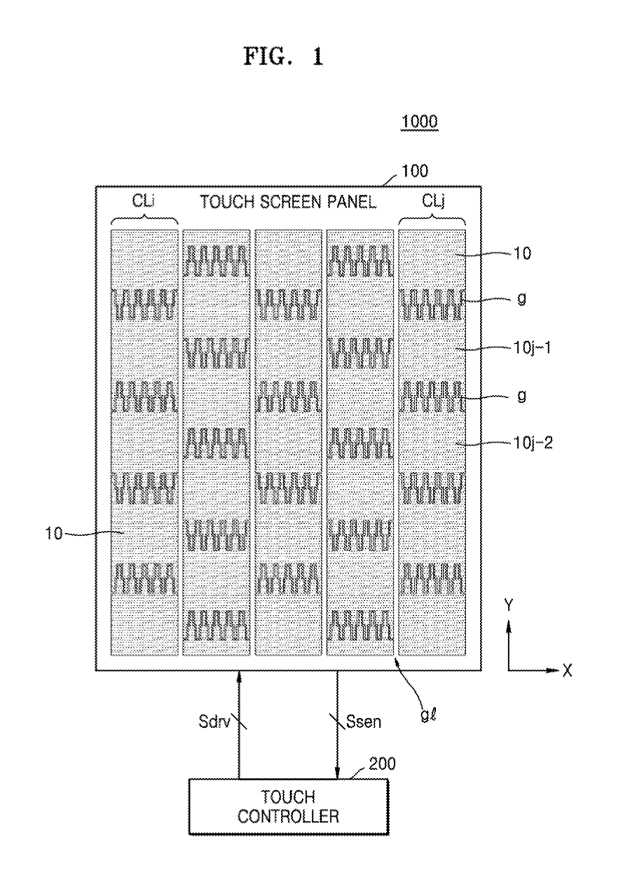

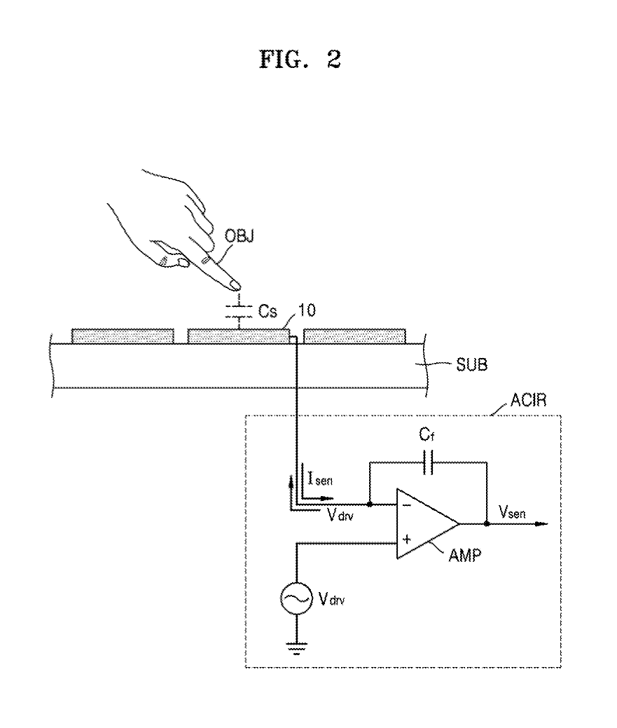

FIG. 1 is a diagram illustrating a touch sensing system 1000 according to an embodiment of the inventive concept. FIG. 2 is a diagram for explaining a method of sensing a touch input on a touch panel 100 using a sensing circuit of system 1000.

Referring to FIG. 1, the touch sensing system 1000 may include the touch panel 100 and a touch controller 200. Hereafter, touch panel 100 will be exemplified as a touch screen panel that overlaps or is integrated with a display screen, but the inventive concept may also be applied to touch panels that do not overlap or integrate with a display screen. The touch screen panel 100 may include a plurality of touch sensing electrodes 10. The plurality of touch sensing electrodes 10 may be composed of a transparent conductive material such as indium tin oxide (ITO), indium zinc oxide (IZO), and indium zinc tin oxide (IZTO), or a metal mesh. For example, the plurality of touch sensing electrodes 10 may be formed by patterning a metal layer on a substrate (SUB in FIG. 2) of the touch screen panel 100.

The plurality of touch sensing electrodes 10 may be arranged in two dimensions across the touch screen panel 100. Sets of touch sensing electrodes 10 may be arranged longitudinally in columns such as columns CLi, CLj. Here, the term “column” is used arbitrarily for convenience of description to refer to any longitudinal arrangement, and does not necessitate a parallel relationship to edges of the overall touch screen panel profile (as noted earlier). A longitudinal axis of each column may be considered aligned with a Y-axis, and a row direction traversing the column direction may be considered an X-axis direction. Meandering isolation gaps g separate adjacent electrodes 10 in the column direction, while linear gaps g1 may separate adjacent columns of electrodes 10. For instance, in column CLj, touch sensing electrodes 10j-1 and 10j-2 are adjacent to one another in the column direction, and are separated by a meandering isolation gap g.

At least some of the touch sensing electrodes 10 may have a comb structure on opposing first and second sides with finger-like protrusions extending in the column direction, which are interdigitated with finger-like protrusions of an adjacent touch sensing electrode 10.

At least some of the touch sensing electrodes 10 may have an oblong profile, with a longest dimension between outermost points of the electrode 10 in the column direction. As will be detailed later, the comb structure may allow for performance benefits such as improved touch sensitivity as compared to conventional art configurations having rectangular or square shaped electrodes with four flush sides. The comb structure may also lead to configuration and/or manufacturing benefits.

In one embodiment, the touch screen panel 100 has a rectangular profile with two long sides and two short sides; the touch sensing electrodes 10 are arranged in columns aligned with the long sides; and at least sonic of the touch sensing electrodes 10 are interdigitated with two adjacent electrodes 10 on opposite sides thereof within the column in which it resides.

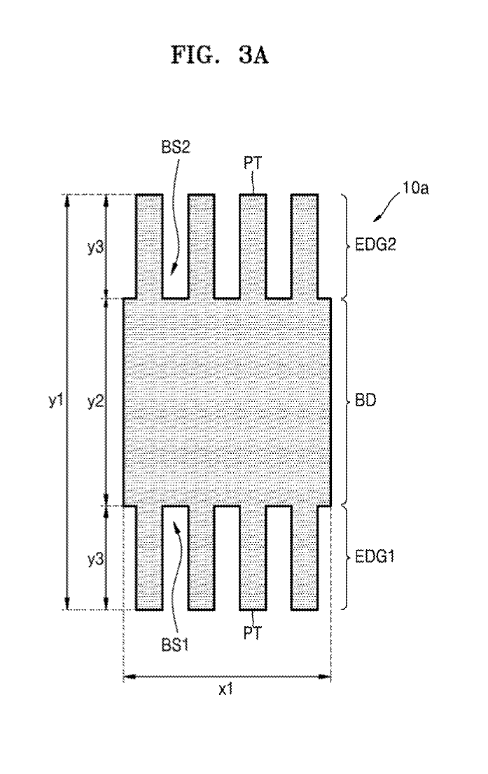

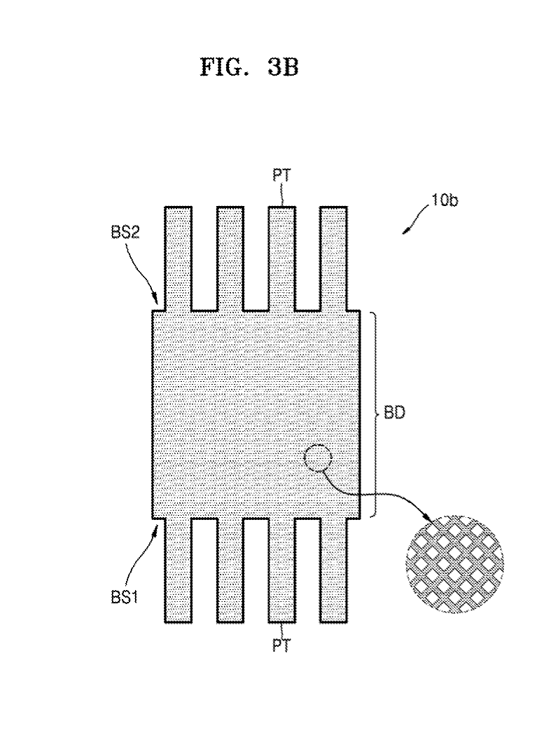

More specifically, as shown in FIG. 1, the touch sensing electrodes 10 may be arranged staggered in a first direction (for example, the X-axis direction) and aligned (in columns or rows) in a second direction (for example, the Y-axis direction) that may be substantially perpendicular to the first direction. In an alternate embodiment, the electrodes 10 may be arranged aligned (in rows or columns) in the first direction as well. Each of the plurality of touch sensing electrodes 10 according to an embodiment of the present disclosure may have a length between outermost points in the second direction that is greater than a length between outermost points in the first direction, and at least one edge portion (interfacing a gap g) may have elongated, finger-like protrusions that each extend in the second direction, yielding a comb structure. Herein, a touch sensing electrode 10 having a central body with edge regions on at least two opposite sides including a plurality of elongated protrusions (e.g. electrode 10j-1 or electrode 10j-2) may be referred to as having a “fishbone” shape. Accordingly, touch sensing electrodes 10 arranged at an identical position in the first direction (i.e., electrodes 10 in a common column) among the plurality of the touch sensing electrodes 10 may be interdigitated via the protrusions with an adjacent electrode 10 in the second direction. Herein, interdigitated should be understood as meaning that protrusions of one electrode 10 extend at least partially within channels between protrusions of another electrode 10, and vice versa. For instance, as shown in FIG. 1, upper protrusions of electrode 10j-2 are arranged in a sequence in the first direction, thereby forming channels between these protrusions. Likewise, the lower protrusions of the adjacent electrode 10j-1 are arranged in a sequence and form channels therebetween. The protrusions of electrode 10j-2 extend within the channels in electrode 10j-1, and vice versa, whereby the electrodes 10j-1 and 10j-2 may be said to he arranged interdigitated via their respective protrusions. An example structure of the touch sensing electrode 10 and an arrangement of the plurality of touch sensing electrodes 10 will be described in more detail with reference to FIGS. 3A through 9B.

As illustrated in FIG. 1, the touch sensing electrodes 10 in adjacent columns may be arranged in a staggered manner with respect to each other in the first direction. However, other embodiments may employ a non-staggered arrangement, where touch sensing electrodes 10 within adjacent columns may be arranged at identical positions in the second direction (i.e., arranged in uniform rows).

It is noted here that in FIG. 1, the touch screen panel 100 is depicted with a rectangular profile with a Y-axis length longer than an X-axis width, and with touch sensing electrodes arranged in columns oriented and interdigitated along the Y-axis direction. In other embodiments where the touch screen panel has such a rectangular profile or another oblong profile oriented the same way, the length of the touch sensing electrode 10 in the first (X) direction may be greater than the length in the second (Y) direction, and the protrusions extend in the first direction. In this case, the touch sensing electrodes 10 arranged at identical positions in the second (Y) direction may be interdigitated with adjacent electrodes 10 in the first (X) direction. In still other embodiments, the profile of the touch screen panel may be symmetrical (square, circular, etc.) In which case the above distinction between first and second directions is not applicable.

One trace may be connected to each of the plurality of touch sensing electrodes 10, respectively (as seen in FIG. 2). A driving signal Sdrv may be applied to the touch sensing electrode 10 via the trace and a sensing signal Ssen generated by the touch sensing electrode 10 may be output from the touch sensing electrode 10. As described above, each of the plurality of touch sensing electrodes 10 respectively connected to one trace may be referred to as a dot sensor, and the trace routes signals to and from the electrode 10.

The touch controller 200 may apply the driving signal Sdrv to each of the plurality of touch sensing electrodes 10 provided on the touch screen panel 100 and detect an occurrence of the touch input and/or a position where the touch input occurs (that is, a touch coordinate) based on the sensing signal Ssen received from the plurality of touch sensing electrodes 10. The touch controller 200 may apply the driving signal Sdrv to the touch sensing electrode 10 via the trace connected to the touch sensing electrode 10 and receive the sensing signal Ssen output from the touch sensing electrode 10.

As illustrated in FIG. 2, when the touch input occurs where a conductive object OBJ, such as a finger, a touch pen, or a stylus pen, is adjacent to or in contact with the touch screen panel 100, a sensing capacitor Cs may be formed between the conductive object OBJ and the touch sensing electrode 10. The sensing signal Ssen may indicate a capacitance value of the sensing capacitor Cs, and the touch controller 200 may generate a touch value corresponding to the touch sensing electrode 10 by detecting the capacitance value of the sensing capacitor Cs based on the sensing signal Ssen. As described above, a touch sensing type in which the capacitance value of the sensing capacitor Cs formed between the touch sensing electrode 10 and the conductive object OBJ is output as the sensing signal Ssen may be referred to as a self-capacitance type.

The touch controller 200 may generate touch data by driving and sensing the touch screen panel 100 of a self-capacitance type. The touch controller 200, as illustrated in FIG. 2 as a non-limiting embodiment, may include an amplifying circuit (ACIR), and the touch sensing electrode 10 may be connected to the ACIR. ACIR may also be referred to herein interchangeably as a sensing circuit. The touch sensing electrodes 10 arranged on an identical column may be sequentially connected to an identical ACIR. For example, the traces connected to each of the touch sensing electrodes 10 arranged in the identical column may be sequentially connected to the ACIR via a multiplexer.

The ACIR may include an amplifier AMP and a feedback capacitor Cf, and the driving voltage Vdrv may be applied to a first input terminal + of the AMP. Since the first input terminal + and a second input terminal − of the AMP are in a virtual short state, a voltage of the second input terminal of the AMP may be substantially equal to the driving voltage Vdrv. Since the touch sensing electrode 10 is connected to the second input terminal − of the AMP via the trace, the driving voltage Vdrv may be applied to the touch sensing electrode 10 as the driving signal (Sdrv in FIG. 1). The touch sensing electrode 10 may generate a sensing current Isen indicating the capacitance value of the sensing capacitor Cs based on the driving voltage Vdrv, and the sensing current Isen may be output as the sensing signal (Ssen in FIG. 1). The ACIR may output the sensing voltage Vsen corresponding to the sensing current Isen by amplifying and converting the sensing current Isen. The sensing voltage Vsen may be digitally converted and generated as the touch value.

The touch controller 200 may generate touch values for each of the plurality of touch sensing electrodes 10, that is, touch data. The touch controller 200 may sense the occurrence of the touch input based on the touch data and calculate the position where the touch input occurs. For example, the touch controller 200 may calculate an accurate touch position by compensating for touch values based on a touch data processing algorithm or by performing other operations, such as interpolation between touch sensing electrodes 10 providing sensing currents Isen above a predetermined threshold indicative of a touch input. In an embodiment, the touch controller 200 may provide the touch data to an external processor, instead of directly calculating the position where the touch input is generated, and the external processor may calculate the position where the touch input is generated based on the touch data.

FIG. 3A is a plan view of an example touch sensing electrode, 10a, according to an embodiment. FIG. 3B illustrates a touch sensing electrode 10b with a profile as in FIG. 3A, with conductive material thereof having a mesh structure. Electrodes 10a and 10b are examples of the electrode 10 discussed herein.

Referring to FIG. 3A, the touch sensing electrode 10a may include a body portion BD and a plurality of protruding portions PT extending in the second direction (Y-axis direction) away from the body portion BD. The plurality of protruding portions PT may be referred to as a first edge portion EDG1 or a second edge portion EDG2.

The body portion BD may have a rectangular or square shape. In other examples the body portion BD may have other shapes such as circular, oval or rhomboid. If the body portion BD has a rectangular shape with two long sides and two short sides, the protruding portions PT may connect to the longer sides in one embodiment, or may connect to the shorter sides in another embodiment. The plurality of protruding portions PT may each be elongated (total length longer than width) and extend from both opposite sides of the body portion BD in the second direction (Y-axis direction). The plurality of protruding portions PT may extend in the direction of the elongation away from the body portion BD in the second direction (Y-axis direction). In an embodiment, the touch sensing electrode 10a may include a plurality of protruding portions PT extending from a first side BS1 of the body portion BD (referred to as a plurality of first protrusions) and a plurality of protruding portions PT extending from a second side BS2 opposite the first side BS1 (referred to as a plurality of second protrusions). The first edge portion EDG1 constituted by the plurality of first protrusions and the second edge portion EDG2 constituted by the plurality of second protrusions may have a symmetrical comb structure at the respective sides of the body portion BD. It is also noted here that in the various illustrated embodiments herein, protruding portions PT are provided on one side or two opposite sides of the body portion BD so that interdigitation with protrusions of an adjacent electrode 10 may occur on those sides of body portion BD in the second direction. In other embodiments, protrusions may be provided on three or four sides to allow for additional interdigitation with adjacent electrodes 10 in the first direction, if the layout permits (particularly, if the layout of traces does not prevent such interdigitation).

A width x1 (for example, a length in the X-axis direction) of the touch sensing electrode 10a may be equal to or less than a height y1 of the touch sensing electrode 10a (for example, a length in the Y-axis direction). The width x1 (that is, a width of the touch sensing electrode 10a) of the body portion BD may be equal to or greater than the height y2 of the body portion BD. In an embodiment, a size of the body portion BD may be similar to a size of the conductive object OBJ (for example, a pointing portion of a human finger or a stylus pen) that is expected to contact the body portion BD. A length y3 of the protruding portion PT may be equal to or less than a length y2 of the body portion BD. As a non-limiting example, the height y1 of the touch sensing electrode 10a may be at least twice the width x1. The width x1 and the length y2 of the body portion BD may be identical. In addition, the length y2 of the body portion BD may be identical to the length y3 of the protruding portion PT. In another example, the length y2 is approximately equal to twice the length y3 of the protrusion portion PT. In still another example, the sum of the lengths y3 on both sides exceeds one half of y2 (i.e., 2y3>y2/2 as in the profile of FIGS. 3A and 3B).

Referring to FIG. 3B, the touch sensing electrode 10b may be implemented as a metal mesh having a fine line width. The shape of the metal mesh may be variously changed. In an embodiment, the touch sensing electrode 10b and the traces may be integrally formed in the same layer.

The touch screen panel (100 in FIG. 1) may be formed integrally with a display panel or may be formed on the display panel. The touch sensing electrode 10 may be arranged on a plurality of pixels provided on the display panel.

As described above with reference to FIG. 3B, when the touch sensing electrode 10b is implemented as a metal mesh, since resistance of a metallic material is low, a signal magnitude of the sensing signal (Ssen in FIG. 1) may be increased. Thus, influence by external noise (for example, display noise) may be reduced. In addition, deterioration of transmittance and visibility of the display panel due to the touch sensing electrode may be reduced by a metal mesh having a fine line width with which the pixels and openings are avoided. Since the touch sensing electrode 10b and the traces may be formed in a single process, the number of masks to be used in a manufacturing process of the touch screen panel 100 may be reduced and thus, a manufacturing cost may be reduced.

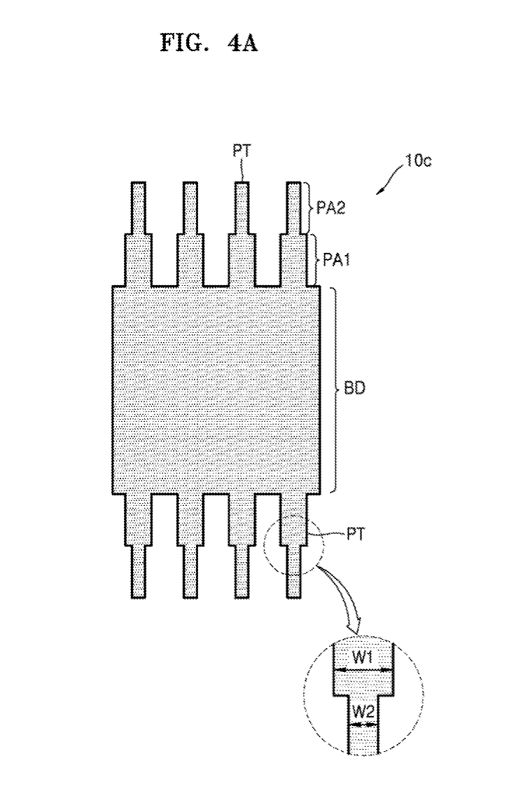

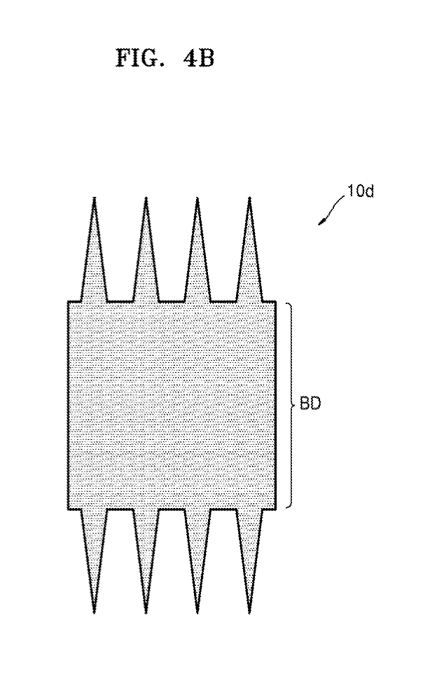

FIGS. 4A and 4B are plan views illustrating touch sensing electrodes 10c and 10d according to embodiments, respectively. The touch sensing electrodes 10c and 10d are examples of electrode 10 discussed herein and are variations of the touch sensing electrode 10a or 10b in FIG. 3A or FIG. 3B, and thus, the description given above with reference to FIGS. 3A and 3B may be applied to similar aspects of the present embodiments.

Referring to FIG. 4A, the protruding portion PT of the touch sensing electrode 10c may include a first partial area PA1 and a second partial area PA2. In FIG. 4A, the protruding portion PT is illustrated as including two partial areas, but in other examples the protruding portion PT may include three or more partial areas.

The first partial area PA1 may be adjacent to the body portion BD and a width W1 of the first partial area PA1 may be greater than a width W2 of the second partial area PA2.

Referring to FIG. 4B, the protruding portion PT of the touch sensing electrode 10d may have a triangular shape with a proximal end connecting with a side of the body portion BD and forming a base of the triangular shape, and with a narrower width toward a distal end of the triangular shape.

As described above with reference to FIGS. 4A and 4B, in the protruding portion PT, a width at a position adjacent to the body portion BD may be greater than a width at another position closer to the distal end. In other words, the width at a position of the protruding portion PT may become narrower away from the body portion BD. Accordingly, when the conductive object OBJ contacts (or is close to) the touch sensing electrode 10c or 10d, the capacitance value of the sensing capacitor Cs (shown in FIG. 2) formed between the touch sensing electrode 10c or 10d and the conductive object OBJ may be reduced, as the contact position of the conductive object OBJ moves away from the body portion BD.

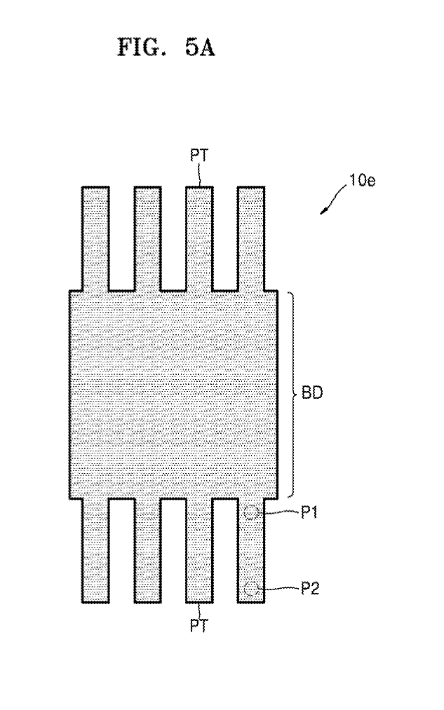

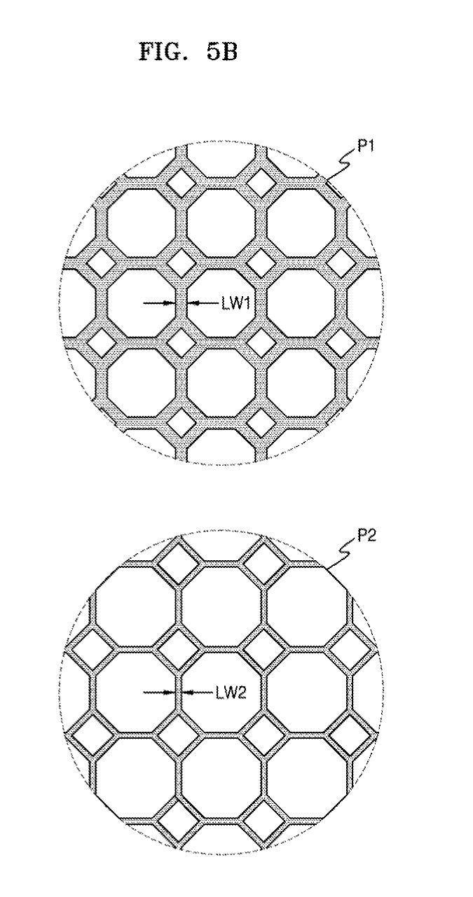

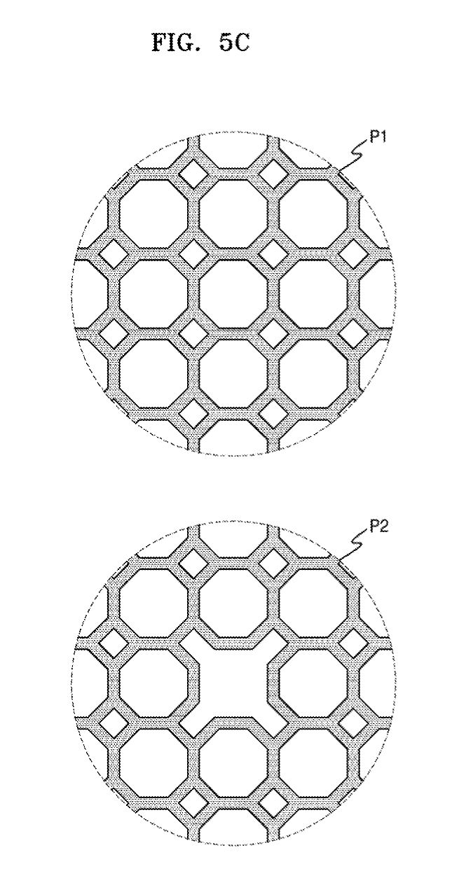

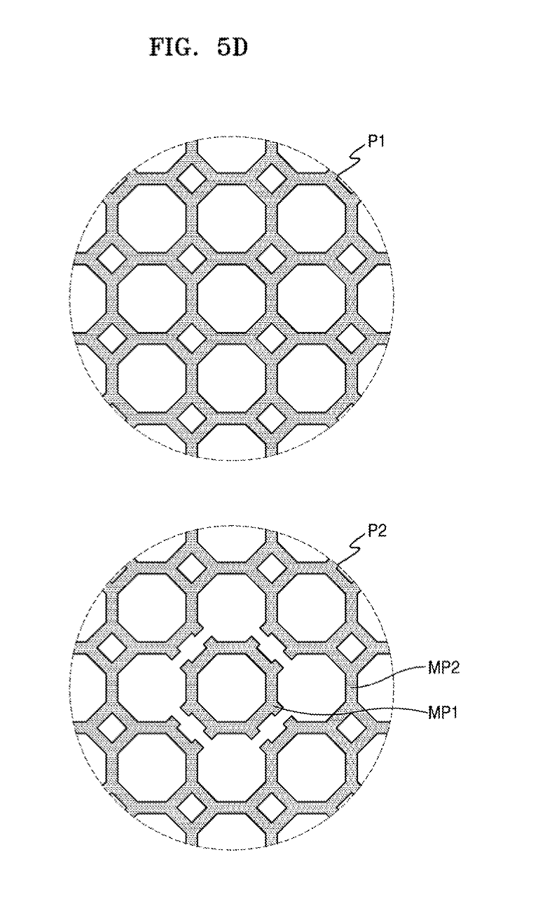

However, as described above with reference to FIG. 3B, when the touch sensing electrode 10b is implemented as a metal mesh, the mesh pattern of the protruding portion PT may be designed to vary, so that the capacitance value of the sensing capacitor Cs formed between the touch sensing electrode 10c or 10d and the conductive object OBJ may be reduced as the contact position in the protruding portion PT moves away from the body portion BD. This is described with reference to FIGS. 5A through 5E.

FIG. 5A is a diagram illustrating a first position P1 and a second position P2 on the protruding portion PT of a touch sensing electrode 10e with a profile as in FIG. 3A, according to an embodiment, and FIGS. 5B through 5E are diagrams illustrating mesh patterns at the first and second positions P1 and P2 in FIG. 5A.

Referring to FIG. 5A, the touch sensing electrode 10e may include the body portion BD and the plurality of protruding portions PT, and may be formed of a metallic mesh. In this case, in the plurality of protruding portions PT, the mesh pattern at a first position P1 (at a proximal end of the protruding portion PT) adjacent to the body portion BD may be different than that at the second position P2 adjacent to the distal end of the protruding portion PT, as shown in FIGS. 5B through 5E. (In other embodiments not utilizing the varying capacitance approach of FIGS. 5B-5E, a uniform mesh may be used throughout the entire areas of the protruding portions PT.)

Referring to FIGS. 5A and 5B, a unit mesh shape of the mesh pattern at the first position P1 and a unit mesh shape of the mesh pattern at the second position P2 may be similar to each other. However, a line width LW1 of the mesh pattern at the first position P1 may be greater than a line width LW2 of the mesh pattern at the second position P2. In an embodiment, the mesh of the protruding portion PT may be formed such that a line width decreases toward the distal end of the protruding portion PT.

Referring to FIG. 5C, a portion of the mesh pattern at the second position P2 may be omitted. Accordingly, a unit density of the mesh pattern at the first position P1 may be greater than the unit density of the mesh pattern at the second position P2. In an embodiment, the mesh of the protruding portion PT may be formed such that omitted portions increase toward the distal end of the protruding portion PT.

Referring to FIG. 5D, in the mesh pattern at the second position P2, a portion of the mesh pattern, for example, a first mesh pattern MP1, may be disconnected from another portion, for example, a second mesh pattern MP2 that is connected to the body portion BD. Accordingly, the unit density of the mesh pattern at the first position P1 may be greater than the unit density of the mesh pattern at the second position P2. Further, the disconnected portion MP2 becomes “floating metal” that may be used as parasitic capacitance. In an embodiment, the mesh of the protruding portion PT may be formed such that portions disconnected from the second mesh portion MP2 increase toward the distal end of the protruding portion PT.

Referring to FIG. 5E, the mesh pattern at the first position P1 may be formed to be finer than the mesh pattern at the second position P2. In other words, a size of a unit mesh of the mesh pattern at the first position P1 may be less than the size of the unit mesh of the mesh pattern at the second position P2. In an embodiment, the mesh of the protruding portion PT may be formed such that the size of the unit mesh increases toward the distal end of the protruding portion PT.

According to the description above, a total conductive material area of the mesh at the first position P1 of the protruding portion PT may be greater than a conductive material area of the mesh at the second position P2. In other words, the unit density of the mesh may decrease toward the distal end of the protruding portion PT. Accordingly, the capacitance value of the sensing capacitor generated when the conductive object OBJ makes contact at the second position P2 may be less than the capacitance value of the sensing capacitor generated when the conductive object OBJ makes contact at the first position P1. In addition, the capacitance value of the sensing capacitor Cs formed between the touch sensing electrode 100 and the conductive object OBJ may be linearly decreased as the contact position of the conductive object OBJ moves away from the body portion BD.

Meanwhile, the unit mesh of the mesh pattern is illustrated as octagonal in FIGS. 5B through 5E, but a shape of the unit mesh may be variously changed in other embodiments.

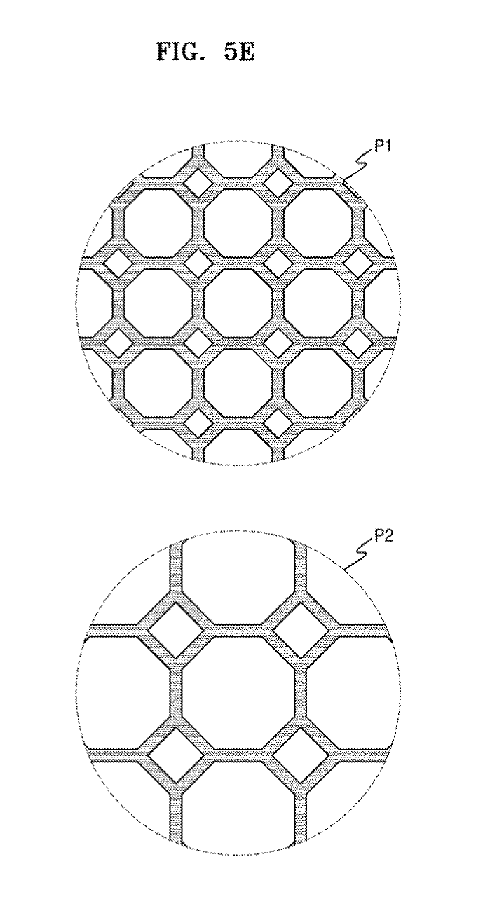

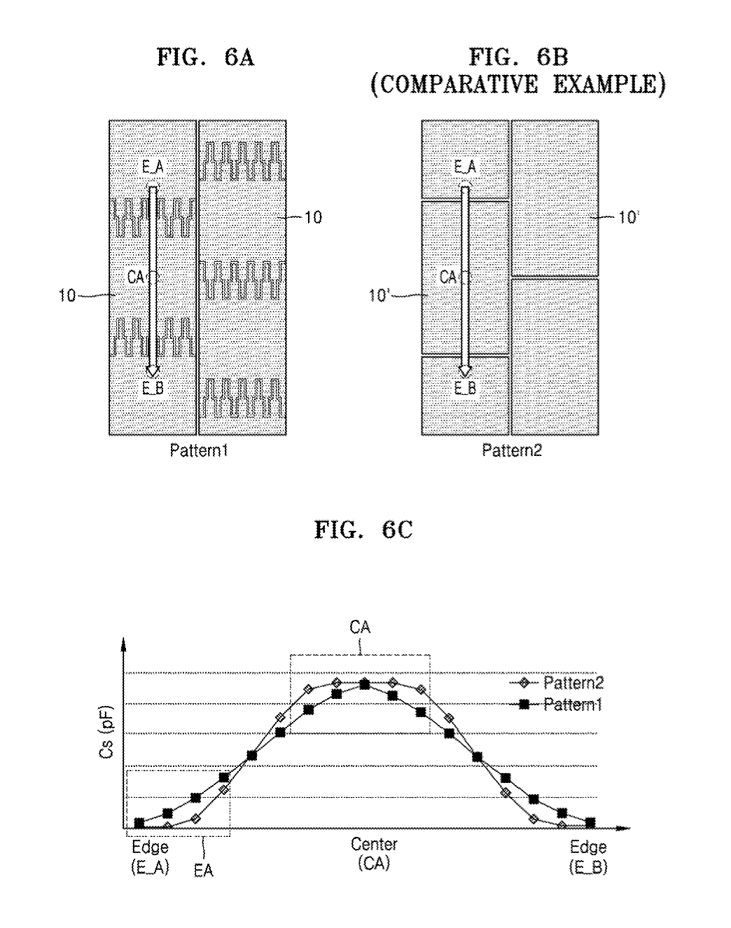

FIG. 6A illustrates a pattern of touch sensing electrodes 10 according to an embodiment of the inventive concept. FIG. 6B illustrates a pattern of touch sensing electrodes, 10′, according to a comparative example. FIG. 6C is a graph of capacitance value of the sensing capacitor Cs, formed in conjunction with a conductive object OBJ, by position of the mesh patterns in FIGS. 6A and 6B. The horizontal axis of the graph of FIG. 6C represents the position on the touch sensing electrode 10 at which the conductive object OBJ contacts either mesh pattern (for example, the position on the vertical (Y) axis in FIG. 6A). The vertical axis of FIG. 6C represents the capacitance value of the sensing capacitor Cs.

Referring to FIG. 6A, the touch sensing electrode 10 according to an embodiment may have a first pattern Pattern1 in a fishbone shape that has an edge thereof including the plurality of protruding portions PT, while the touch sensing electrode 10′ according to the comparative example may have a second pattern Pattern2 having a rectangular shape with four flush sides and with linear gaps separating the electrodes 10′ on all sides. When the conductive object OBJ moves from a first edge E_A to a second edge E_B while in contact with (or close proximity to) the touch sensing electrodes 10 and 10′, the capacitance value of the sensing capacitor Cs may appear as illustrated in FIG. 6C.

Referring to FIG. 6C, in the case of the second pattern Pattern2 corresponding to the touch sensing electrode 10′ according to the comparative example, a change in the capacitance value is small in the center area CA, and thus it may be difficult to precisely identify different touch positions across the center area CA by capacitance value. However, in the case of the first pattern Pattern1 corresponding to the touch sensing electrode 10 according to the embodiment, the change in the capacitance value in the center area CA is approximately linear. Thus, when the conductive object OBJ moves in the second direction, for example, the Y-axis direction, from the center area CA of the touch sensing electrode 10, a change in the position of the touch input may be effectively sensed based on the change in the capacitance value.

In addition, in the case of the second pattern Pattern2, the change of the capacitance value by position in the edge area EA is non-linear and nearly zero over a range of positions near the gap region between adjacent electrodes 10′. Thus, it is difficult to identify the capacitance value at the positions adjacent to the gap region. However, in the case of the first pattern Pattern1, the change in the capacitance value in the edge area EA is more linear and the capacitance values are higher as compared to the comparative example. When an adjacent touch sensing electrode 10 mainly senses the touch input (for example, when the center of the conductive object OBJ is positioned on another touch sensing electrode 10), the sensing signal of the touch sensing electrode 10 may be used as an auxiliary indicator for calculating the position of the touch input. Since the capacitance value change in the edge area EA of the touch sensing electrode according to the embodiment of the present disclosure is constant and stable, usability of the sensing signal of the touch sensing electrode may be improved when the sensing signal of the touch sensing electrode is used as an auxiliary indicator of another touch sensing electrode.

As described above with reference to FIG. 1, when the touch screen panel 100 is implemented with the dot sensors in which traces are connected to each of the plurality of touch sensing electrodes 10, the number of channels, which may equal the number of traces, may be very large. Since the touch controller 200 drives and senses each of the plurality of touch sensing electrodes 10, the greater the number of electrodes 10, the longer the time that may be consumed for such processes of the touch controller 200. In addition, the larger the number of electrodes 10, the larger the area occupied by the touch controller 200 because the number of circuits (for example, the number of ACIRs in FIG. 2) for driving and sensing is large. However, when the area of each touch sensing electrode 10 is increased in a conventional way to reduce the number of channels, the touch sensing sensitivity may be reduced.

A touch sensing electrode 10 according to the embodiment of the present disclosure has an oblong profile with a longest dimension (which may be called the electrode 10′s length) in one direction that is longer than the longest dimension in an orthogonal direction, which may be called the electrode 10′s width. Compared to a square electrode with a dimension of each side equaling the width of electrode 10, the area of the touch sensing electrode 10 may be greater. Thus, with embodiments of the inventive concept, the total number of touch sensing electrodes provided on the touch screen panel may be reduced as compared to conventional devices. In addition, since the touch sensing electrode 10 is formed with finger-like protrusions on opposite sides in the length direction, and interdigitated with an adjacent electrode 10, a touch sensing sensitivity may be improved. Therefore, in the touch screen panel 100 the touch sensing sensitivity may be improved compared to the conventional art while the total number of touch sensing electrodes 10 is reduced. In addition, since the total number of touch sensing electrodes 10 is reduced, the number of circuits for driving and sensing the touch sensing electrodes 10 may be reduced, and thus, the area of the touch controller (200 in FIG. 1) may be reduced.

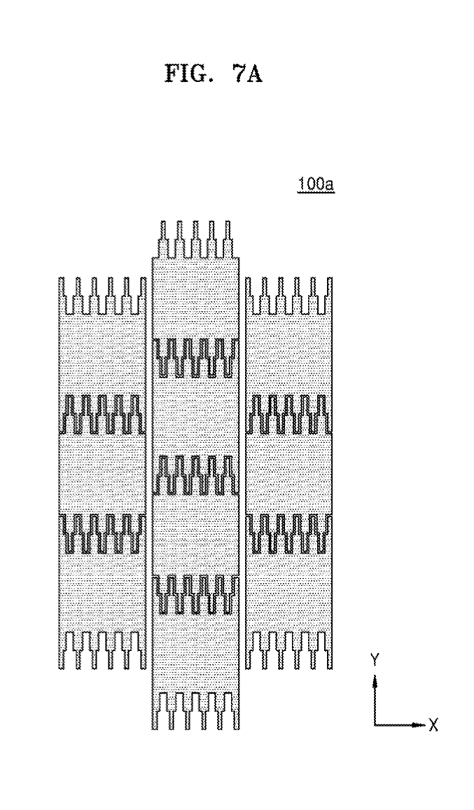

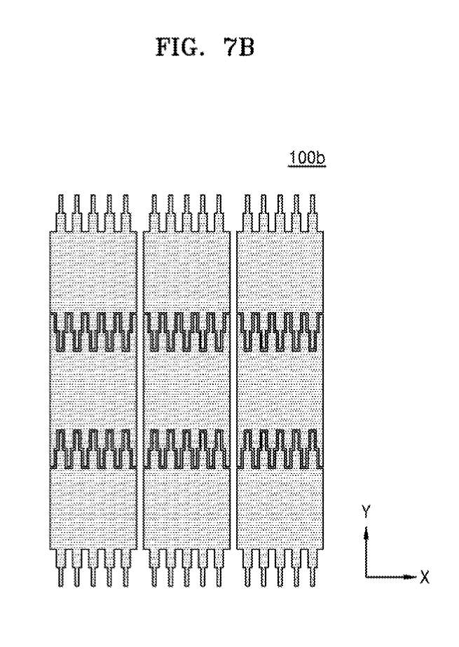

FIGS. 7A and 7B are diagrams illustrating arrangements of the touch sensing electrodes 10 of touch screen panels 100a and 100b according to respective embodiments.

Referring to FIG. 7A, in the touch screen panel 100a according to the embodiment, the plurality of touch sensing electrodes 10 may be arranged in a staggered manner. The plurality of touch sensing electrodes 10 may be arranged in the second direction (for example, the Y-axis direction) at an identical position in the first direction (e.g., the X-axis direction) to form a column, and the plurality of touch sensing electrodes 10 may be interdigitated with each other in the second direction. In this case, the touch sensing electrodes 10 in adjacent columns may be arranged to be staggered from each other. Accordingly, when the touch input is generated on one touch sensing electrode 10, touch values based on sensing signals of adjacent touch sensing electrodes that are arranged in a staggered manner may be used as auxiliary indicators in calculation of the touch coordinate. In the embodiment of FIG. 7B, in the touch screen panel 100b, the plurality of touch sensing electrodes 10 are orthogonally arranged in the first direction and the second direction. In other words, the electrodes 10 are arranged in uniform columns and rows in the touch screen panel 100b.

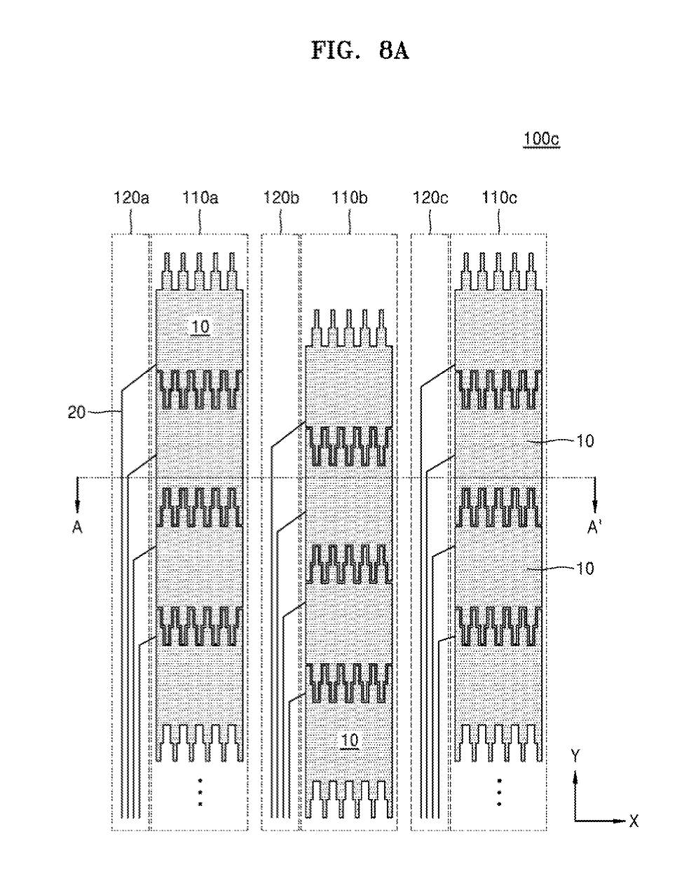

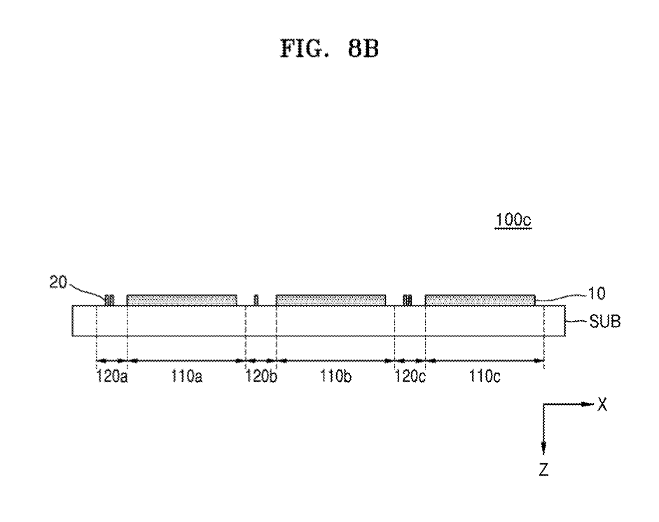

FIGS. 8A and 8B are diagrams illustrating a touch screen panel 100c according to an embodiment. FIG. 8A is a plan view of the touch screen panel 100c, and FIG. 8B is a cross-sectional view of the touch screen panel 100c taken along the line A-A′ in FIG. 8A (with certain portions of traces removed for clarity).

Referring to FIGS. 8A and 8B, the touch screen panel 100c may include the plurality of touch sensing electrodes 10 and a plurality of traces 20 respectively connected to the plurality of touch sensing electrodes 10. The plurality of touch sensing electrodes 10 and the plurality of traces 20 may be formed on a same layer on the substrate SUB. For example, the plurality of touch sensing electrodes 10 and the plurality of traces 20 may be formed on a common surface of the substrate SUB.

The touch screen panel l 00c may include a plurality of touch sensing areas such as first, second and third touch sensing areas 110a, 110b and 110c that form respective columns of touch sensing electrodes, and a plurality of trace areas such as first, second and third trace areas 120a, 120b and 120c, respectively. In FIG. 8A, the touch screen panel 100c is illustrated to include three touch sensing areas and three trace areas, but the number of the touch sensing areas and the trace areas may vary according to design for a target touch resolution and the overall size of the touch panel, and in practice there may be tens, hundreds or in excess of a thousand touch sensing areas and trace areas. The first through third touch sensing areas 110a through 110c and the first through third trace areas 120a through 120c may be alternately arranged. (Note that in the cross-sectional view of FIG. 8B, the slanted portions of some of the traces 20 connecting to the electrodes 10 are removed for clarity.)

The plurality of touch sensing electrodes 10 may be formed in column units in the first through third touch sensing areas 110a through 110c, and the traces 20 connected to the plurality of touch sensing electrodes 10 formed in one of the first through third touch sensing areas 110a through 110c may be formed in an adjacent one of the first through third trace areas 120a through 120c. For example, the traces 20 connected to the touch sensing electrodes 10 formed in the first touch sensing area 110a may be formed in the first trace area 120a arranged adjacent to the first touch sensing area 110a.

In an embodiment, the touch sensing electrode 10 may be implemented as a metal mesh of fine line width, and the trace 20 may include the same material as the touch sensing electrode 10 and may be integrally formed with the touch sensing electrode 10.

According to the embodiment of FIGS. 8A and 8B, since the touch sensing electrode 10 and the trace 20 are formed on an identical layer, the touch sensing electrode 10 and the trace 20 may be formed in a single process. Accordingly, the number of masks used in a manufacturing operation of the touch screen panel 100c may be reduced, and thus, manufacturing cost may be reduced.

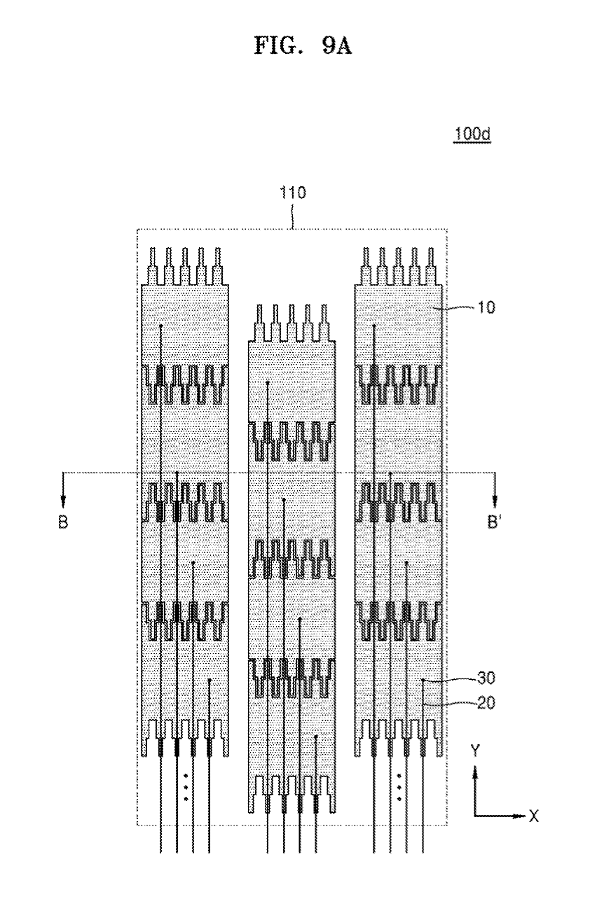

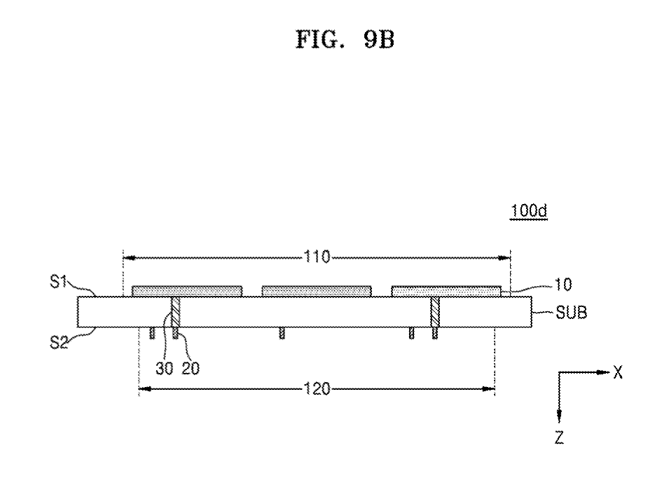

FIGS. 9A and 9B are diagrams illustrating a touch screen panel 100d according to an embodiment. FIG. 9A is a plan view of the touch screen panel 100d and FIG. 9B is a cross-sectional view of the touch screen panel 100d taken along the line B-B′ in FIG. 9A. This cross-sectional view may be considered a vertical cross-sectional view assuming that the major surface of the touch screen panel is oriented horizontally.

As shown in FIGS. 9A and 9B, the touch screen panel 100d may include the plurality of touch sensing electrodes 10 and the plurality of traces 20, each respectively connected to one of the plurality of touch sensing electrodes 10. The plurality of touch sensing electrodes 10 and the plurality of traces 20 may be formed on different layers from each other. For example, the plurality of touch sensing electrodes 10 may be formed on a first surface S1 of the substrate SUB and the plurality of traces 20 may be formed on a second surface S2 of the substrate SUB. A touch sensing area 110 may be formed on the first surface S1 of the substrate SUB and a trace area 120 may be formed on the second surface S2 of the substrate SUB. Each trace 20 may be connected to a respective touch sensing electrode 10 through a via 30.

According to the present embodiment of FIGS. 9A and 9B, since the touch sensing electrodes 10 and the traces 20 are formed on different layers from each other, it is not necessary to arrange a separate trace area on the layer in which the touch sensing electrode 10 of the touch screen panel 100d is formed. Accordingly, the area of the touch sensing electrode 10 may be increased as compared to designs employing a single layer for these elements. Further, gaps between adjacent sets of electrodes 10 arranged longitudinally (e.g. in columns) may be smaller. Therefore, the touch sensing sensitivity may be increased.

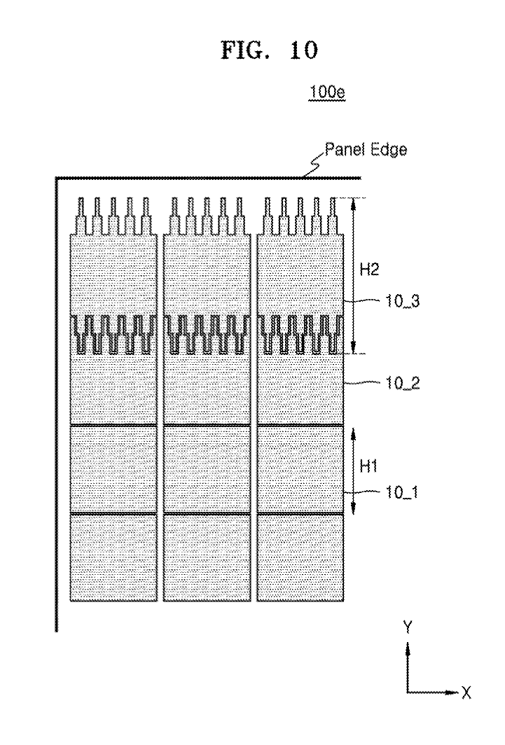

FIG. 10 is a diagram illustrating a touch screen panel 100e according to an embodiment. Touch screen panel 100e may include a plurality of touch sensing electrodes 10 arranged in a matrix. In this case, a third touch sensing electrode 10_3 arranged on a panel edge of the touch screen panel 100e may be implemented as one of the touch sensing electrodes 10a, 10b, 10c, 10d, and 10e according to the embodiments of the present disclosure described above with reference to FIGS. 3A through 5E.

For example, a first touch sensing electrode 10_1 arranged at the center portion of the touch screen panel 100e may be square. The third touch sensing electrode 10_3 arranged on the panel edge of the touch screen panel 100e may have a fishbone shape, and a length H2 of the third touch sensing electrode 10_3 may be greater than a length H1 of a first touch sensing electrode 10_1. In an embodiment, a second touch sensing electrode 10_2 adjacent to the third touch sensing electrode 10_3 may have a comb structure having a plurality of protruding portions PT on one side so as to be staggered with the third touch sensing electrode 10_3.

Depending on a size of the touch screen panel 100e, the length H2 of the third touch sensing electrode 10_3 arranged at the panel edge region of the touch screen panel 100e may be greater or less than the length H1 of the first touch sensing electrode 10_1 arranged at the center portion of the touch screen panel 100e. When the length H2 of the third touch sensing electrode 10_3 arranged on the panel edge region is relatively long, the touch sensing sensitivity may be reduced at the edge region of the touch screen panel 100e. On the other hand, when the length H2 of the third touch sensing electrode 10_3 arranged at the panel edge region is relatively short, the total number of touch sensing electrodes 10 of the touch screen panel 100e may be increased.

However, in the touch screen panel 100e according to the embodiment of the present disclosure, the total number of the touch sensing electrodes may be reduced and additionally, degradation of the touch sensing sensitivity thereof may be prevented, by forming the length H2 of the third touch sensing electrode 10_3 arranged at the panel edge region of the touch screen panel 100e to be greater than the length H1 of the first touch sensing electrode 10_1 arranged at the center portion of the touch screen panel 100e while forming the third touch sensing electrode 10_3 in a fishbone shape.

In the touch screen panel 100e having the above-described configuration, as compared to conventional configurations utilizing squares and/or rectangular shaped electrodes with flush sides, the sensing sensitivity may be improved and/or a reduced number of electrodes may be used for the same size touch screen panel.

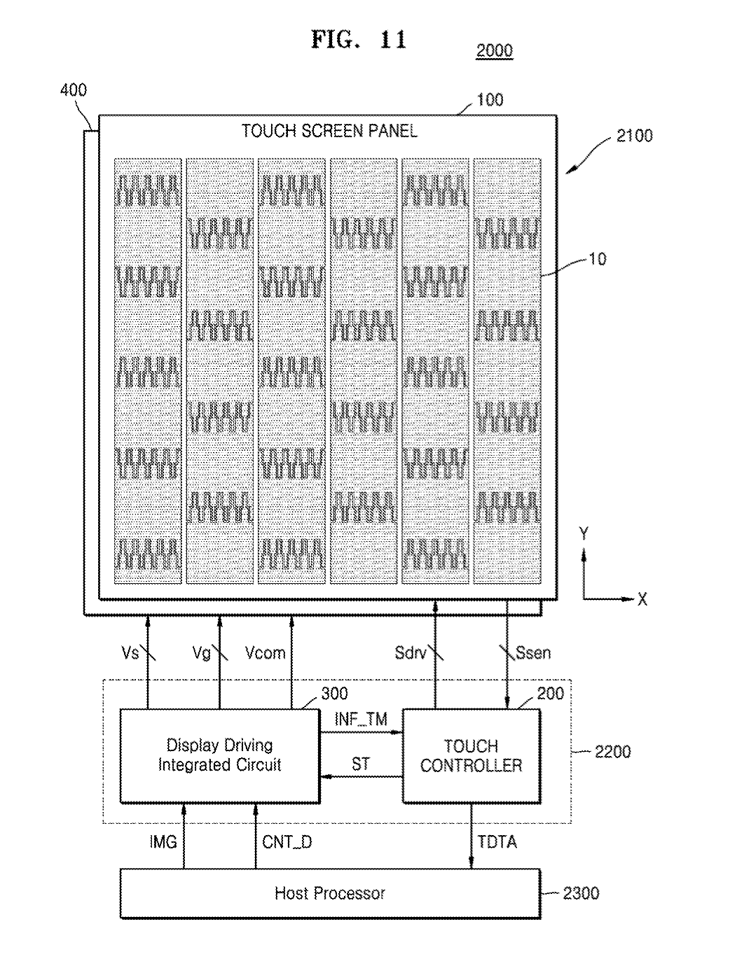

FIG. 11 is a block diagram illustrating an electronic system 2000 including the touch screen panel 100 according to an embodiment. Electronic system 2000 may include a touch display 2100, a driving circuit 2200 for driving the touch display 2100, and a host processor 2300.

The touch display 2100 may include the touch screen panel 100 and a display panel 400. The touch screen panel 100 may have any of the configurations described hereinabove.

For instance, the touch screen panel 100 may include the plurality of touch sensing electrodes 10 and the plurality of touch sensing electrodes 10 may be arranged in the first direction (for example, the X-axis direction) and in the second direction (for example, the Y-axis direction). Each of the plurality of touch sensing electrodes 10 may have a length (for example, a length in the Y-axis direction) greater than a width (for example, a length in the X-axis direction), and may have a comb structure in which at least one panel edge in the second direction includes the plurality of protruding positions PT. The touch sensing electrodes 10 arranged at an identical position in the first direction among the plurality of the touch sensing electrodes 10 may be interdigitated with each other in the second direction. In an embodiment, the touch sensing electrodes 10 on adjacent columns may be arranged in a staggered manner from each other. In an embodiment, the touch sensing electrode 10 may have a metallic mesh, and the traces connected to each of the plurality of touch sensing electrodes 10 may be formed integrally with the touch sensing electrodes 10 on an identical layer.

The display panel 400 may include gate lines, data lines, and a plurality of pixels arranged in a matrix and connected to the gate lines and the data lines. The display panel 400 may be implemented as a liquid crystal display (LCD), a light emitting diode (LED) display, an organic LED (OLED) display, an active matrix OLED (AMOLED) display, and/or a flexible display, or may be implemented with other types of flat panel displays.

In an embodiment, the touch screen panel 100 and the display panel 400 may be integrally formed. For example, the touch sensing electrode 10 may be formed in an in-cell type or an on-cell type in a pixel of the display panel 400.

The driving circuit 2200 may include the touch controller 200 and a display driving integrated circuit 300. In an embodiment, the touch controller 200 and the display driving integrated circuit 300 may be implemented in one semiconductor chip, which may be referred to as a touch display drive integrated chip (TDDI). Alternatively, the touch controller 200 and the display driving integrated circuit 300 may be implemented as separate chips.

The display driving integrated circuit 300 may drive the display panel 400. The display driving integrated circuit 300 may provide a common voltage Vcom, gate voltages Vg, and source voltages Vs (or data signals) to the display panel 400.

The display driving integrated circuit 300 may receive a video signal IMG and a control signal CNT_D from the host processor 2300, and output to the display panel 400 an image corresponding to the video signal IMG based on the received video signal IMG and control signal CNT_D. As an example, the host processor 2300 may be implemented as a system on chip (SoC) such as an application processor (AP). The display driving integrated circuit 300 may provide timing information INF_TM to the touch controller 200. The timing information INF_TM may include, for example, a vertical synchronization signal, a horizontal synchronization signal, and the like.

The touch controller 200 may detect touch input and/or touch coordinates on the touch screen panel 100. The touch controller 200 may generate touch position information and/or touch pressure information based on the detected touch signal and pressure signal, and output the touch position information and/or the touch pressure information to the host processor 2300 as touch data (TDTA).

In an embodiment, the touch controller 200 may generate various timing signals based on the timing information INF_TM provided from the display driving integrated circuit 300. Further, the touch controller 200 may sense the touch input in an area other than a display driving area based on the timing information INF_TM. The touch controller 200 may provide status information ST thereof to the display driving integrated circuit 300.

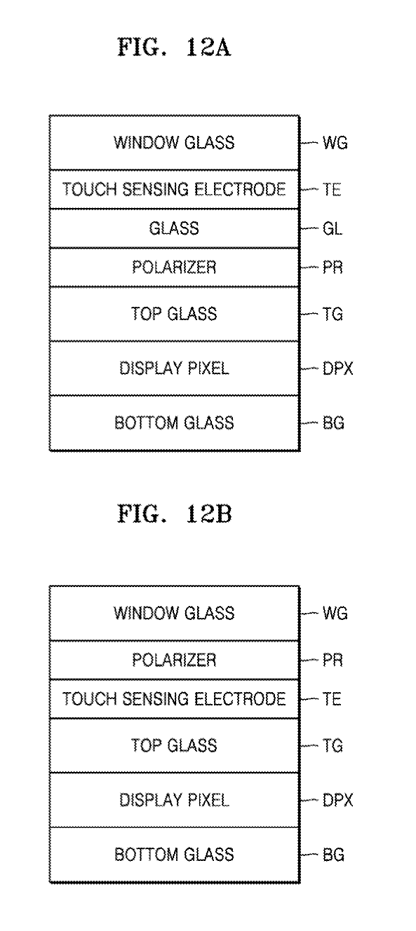

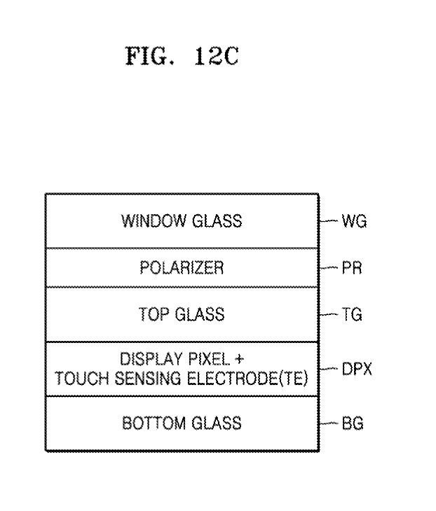

FIGS. 12A, 12B and 12C are vertical cross-sectional views schematically illustrating respective example laminated structures of the touch display 2100 in FIG. 11.

Referring to FIG. 12A, a touch sensing electrode TE, a glass GL, a polarizer PR, a top glass TG, a display pixel DPX, and a bottom glass BG may be sequentially stacked under a window glass WG. The display panel (400 in FIG. 11) may include the polarizer PR, the top glass TG, the display pixel DPX, and the bottom glass BG, and the touch screen panel (100 in FIG. 11) may include the window glass WG, the touch sensing electrode TE, and the glass GL. According to the present embodiment, the touch screen panel 100 may be formed separately from the display panel 400, and the touch sensing electrode TE may be patterned on the glass GL, which may be a dedicated substrate of the display panel 400.

Referring to FIG. 12B, the polarizer PR, the touch sensing electrode TE, the top glass TG, the display pixel DPX, and the bottom glass BG may be sequentially stacked under the window glass WG. According to this embodiment, the touch screen panel 100 may be formed in the on-cell type in which the touch sensing electrode TE is patterned on the top glass TG of the display panel (400 in FIG. 11).

Referring to FIG. 12C, the polarizer PR, the top glass TG, the display pixel DPX, and the bottom glass BG may be sequentially stacked under the window glass WG. The touch sensing electrode TE may be formed integrally with the display pixel DPX. In other words, the touch screen panel 100 may be formed in the in-cell type in which the touch sensing electrode TE is formed in the display pixel DPX. In an embodiment, the touch sensing electrode TE may be implemented as a common electrode of the display pixel DPX.

The above-described embodiments have been described in reference to the drawings, in which various numbers of electrodes 10 with protruding portions PT on at least one side thereof are illustrated as forming part of a touch screen panel. In various embodiments, the number of such electrodes 10 may be set by a designer, and in an extreme case, a configuration having only a single such electrode may be advantageous for a targeted application (e.g. when it is desired to improve sensitivity only in a local region of the touch panel).

In addition, touch screen panels according to the above embodiments have been described as including touch sensing electrodes 10 with a comb-like structure (having a sequence of protruding portions PT) on one or two sides of a body portion BD. In other embodiments of a touch screen panel 100, at least some of the electrodes 10 may have protruding portions PT on three or four sides of the body portion BD. In this case, an electrode 10 may be interdigitated via the protrusions with up to four adjacent electrodes on four respective sides thereof. That is, an electrode 10 may be interdigitated with upper and lower adjacent electrodes on upper and lower sides in the second direction, and with left side and right side adjacent electrodes 10 on left and right sides of the body portion BD, respectively, in the first direction.

While the inventive concept described herein has been particularly shown and described with reference to example embodiments thereof, it will be understood by those of ordinary skill in the art that various changes in form and details may be made therein without departing from the spirit and scope of the claimed subject matter as defined by the following claims and their equivalents.

What is claimed is:

1. A touch panel comprising:
a substrate; and
a plurality of electrodes arranged on the substrate, the plurality of electrodes being interdigitated with each other,
wherein each of the plurality of electrodes comprises: a body portion; and a plurality of protruding portions extending away from the body portion, wherein the plurality of electrodes are interdigitated with each other via the protruding portions.

2. The touch panel of claim 1, wherein the plurality of electrodes are aligned in a second direction and the touch panel further comprising a plurality of traces respectively connected to the plurality of electrodes to route signals to and from the plurality of electrodes, the plurality of traces extending in the second direction.

3. The touch panel of claim 2, wherein the traces are formed with the plurality of electrodes in an identical layer.

4. The touch panel of claim 2, wherein the plurality of electrodes are each formed as a metal mesh having a pattern, and the plurality of traces are integrally formed with the plurality of electrodes.

5. The touch panel of claim 1, wherein the body portion is rectangular; the plurality of protruding portions comprise a plurality of first protruding portions extending from a first side of the body portion and a plurality of second protruding portions extending from a second side of the body portion, the second side being opposite the first side; and the plurality of first protruding portions of at least one of the plurality of electrodes are interdigitated with the plurality of second protruding portions of a first adjacent electrode of the plurality of electrodes, and the plurality of second protruding portions of the at least one of the plurality of electrodes are interdigitated with the plurality of first protruding portions of a second adjacent electrode of the plurality of electrodes.

6. The touch panel of claim 1, wherein a second length equaling a longest dimension of each of the plurality of electrodes in a second direction is greater than a first length equaling a longest dimension of each of the plurality of electrodes in a first direction perpendicular to the second direction.

7. The touch panel of claim 6, wherein a length of the body portion in the first direction is equal to or greater than a length of the body portion in the second direction.

8. The touch panel of claim 1, wherein a capacitor is formed between the plurality of protruding portions and a conductive object, wherein a capacitance value of the capacitor at a first position at a proximal end of the protruding portions adjacent to the body portion is greater than a capacitance value of the capacitor at a second position at a distal end of each of the plurality of protruding portions.

9. The touch panel of claim 8, wherein for each of the protruding portions, a width of the protruding portion at the first position is greater than a width of the protruding portion at the second position.

10. The touch panel of claim 8, wherein each of the plurality of protruding portions is formed as a mesh, and a line width of the mesh at the first position is greater than a line width of the mesh at the second position.

11. The touch panel of claim 8, wherein each of the plurality of protruding portions is formed as a mesh, and a unit density of the mesh at the first position is greater than a unit density of the mesh at the second position.

12. The touch panel of claim 1, wherein the plurality of electrodes is a plurality of first electrodes arranged in a first column aligned in a second direction, and the touch panel further comprising a plurality of second electrodes arranged in a second column aligned in the second direction, each of the plurality of second electrodes being interdigitated with each other in the second direction; and the plurality of first electrodes and the plurality of second electrodes are arranged in a staggered manner with respect to a first direction perpendicular to the second direction.

13. The touch panel of claim 1, wherein the touch panel is a touch screen panel integrated with a display.

14. A touch sensing system comprising:
a touch screen panel including a plurality of touch sensing electrodes and a plurality of traces respectively connected to the plurality of touch sensing electrodes; and
a touch controller configured to provide a driving signal to the plurality of touch sensing electrodes via the plurality of traces and acquire touch data based on a sensing signal received from the plurality of touch sensing electrodes via the plurality of traces,
wherein each of the plurality of touch sensing electrodes comprises a body portion, a first edge portion and a second edge portion formed integrally with the body portion at respective first and second sides of the body portion, and each having a symmetrical comb structure.

15. The touch sensing system of claim 14, wherein the first and second sides of the body portion are opposite sides of the body portion, and the touch screen panel comprises:
a first sensing area in which first electrodes among the plurality of touch sensing electrodes are arranged in a first column in a column direction and interdigitated with each other via the comb structures thereof;
a second sensing area in which second electrodes among the plurality of touch sensing electrodes are arranged in a second column parallel to the first column and interdigitated with each other via the comb structures thereof; and
a trace area in which a subset of the plurality of traces, connected to the first electrodes or the second electrodes, are disposed, wherein the trace area is between the first sensing area and the second sensing area, and extends in the column direction.

16. The touch sensing system of claim 15, wherein the first electrodes and the second electrodes are arranged in a staggered manner with respect to an axis transverse to the column direction.

17. The touch sensing system of claim 14, wherein the first edge portion comprises a plurality of protruding portions extending from the first side of the body portion and forming the symmetrical comb structure thereat,
wherein each of the plurality of protruding portions comprises:
a first portion connected to the body portion and having a first width; and
a second portion connected to the first portion and having a second width less than the first width.

18. A touch screen panel comprising:
a touch sensing area including a plurality of touch sensing electrodes, wherein each of the plurality of touch sensing electrodes comprises a metallic mesh, and at least one of the plurality of touch sensing electrodes comprises a body portion and a plurality of protruding portions extending from the body portion; and
a trace area including a plurality of traces each connected to a respective one of the plurality of touch sensing electrodes.

19. The touch screen panel of claim 18, wherein the touch sensing area and the trace area are integrally formed in an identical layer on the substrate.

20. The touch screen panel of claim 18, further comprising, in combination therewith, a display panel in which a plurality of pixels for displaying a video signal are formed, wherein the display panel is formed on a first layer, and the touch sensing area and the trace area are formed on a second layer that vertically overlaps the first layer.
